(19) United States
(12) Patent Application Publication
(10) Pub. No.: US 2012/0263564 A1
(43) Pub. Date: Oct. 18, 2012

(54) HEAVY OBJECT CASSETTE TRANSFERRING APPARATUS AND A TRANSFERRING METHOD THEREOF

(76) Inventors: Yukio Takeuchi, Tokyo (JP); Satoru Nooka, Tokyo (JP)

(21) Appl. No.: 13/519,677

(22) PCT Filed: Feb. 25, 2010
(86) PCT No.: PCT/JP2010/052993

§ 371 Date: Jul. 6, 2012

(51) Int. Cl. B66F 9/06

(52) U.S. Cl. 414/664; 414/814

(57) ABSTRACT

It is intended to provide a transferring apparatus for a heavy object cassette as well as a transferring method for the heavy object cassette, which is mainly operable mechanically without using hydraulic pressure, by which it is easy to load the heavy object cassette and an operation speed is improved. The transferring apparatus is provided with a heavy object cassette which is a heavy object contained in a cassette integrally, a common steel plate 15 to which support rods 6a, 6c are fixed, the support rods being inserted in holes 4a formed horizontally in the heavy object cassette 4, and a play mechanism 51 which allows adjustment of a relative position between the holes 4a and the support rods 6a, 6c by adjusting a position of the common steel plate 15, a base unit 7 having thereon the play mechanism 51 and a lifting and lowering device 5, and a slide mechanism 72 which supports the base unit 7 movable forward and backward relative to a main body 71 of the transferring apparatus.

### TECHNICAL FIELD

The present invention relates to an apparatus and a device for transferring a heavy object cassette formed by winding a belt-shaped material around a drum-shaped member, in which a plurality of support rods are, respectively, inserted in a plurality of holes formed in the heavy object cassette so as to hold the heavy object cassette via the support rods.

### BACKGROUND ART

FIG. 6 shows one example of a heavy object cassette transferring device in relation to the related art, where a heavy object weighing approximately 100 kg is unloaded from a table after winding a belt-shaped material around a drum-shaped member and then moved onto a transferring cart.

FIG. 6 sows an arm 05 fixed to an end of a support 051 installed upright on the ground 101, and a wire winch 055, 054, 056 provided at an end of the arm 052 via a hinge mechanism 053. To a lower part 056 of the wire winch, a slide mechanism is connected. To the slide mechanism 057, a carrying unit 060 is installed movable in a horizontal direction.

In the carrying unit 060, three support rods 058, 058, 059 are installed horizontally. The bottom support rod 059 functions as a stopper to prevent the heavy object cassette from falling after the support rods 058, 058 are inserted in holes formed in the heavy object cassette 060. The slide mechanism 057 has a leg 057a which is movable horizontally (in a range indicated with S). When the heavy object cassette 060 is picked up, the leg 057a moves leftward in the drawing to return to its original position so as to keep balance.

Further, in Patent Literature 1 (JP5-106127A) disclosed is an apparatus for automatically mounting a cake in which a cake mount supporting a winded cake having a yarn winded around is positioned in advanced at a prescribed position of a corresponding twisting machine and by controlling a robot body by the apparatus, the winded cake supported on the cake mount is removed and mounted automatically on a creel successively.

### CITATION LIST

### Patent Literature

### [Patent Literature 1]

JP 5-106127 A

### SUMMARY OF INVENTION

### Technical Problem

In the transferring apparatus of FIG. 6, the wire winch 055, 054, 056 is provided at the end of the arm 052 and by hoisting and lowering the wire winch, the carrying unit 060, three support rods 058, 058, 059 and the heavy object cassette 060 are integrally hoisted and lowered. Thus, the lifting and lowering the heavy object cassette 060 is slow and inefficient.

Further, the support 051 is installed on the ground 101 and the transferring apparatus for the heavy object is fixed on the ground. Thus, it is extremely difficult to change the layout and the range of movement is small.

Furthermore, in the transferring apparatus of FIG. 6, the operation of the apparatus requires many adjustments such as balancing the heavy object cassette 060 horizontally and adjusting the movable range S of the slide mechanism 057 and it takes time to get used to the operation, resulting in poor operation efficiency.

The use of the oil pressure for the slide mechanism 057 and so on, causes issues such as frequent failures by oil leaks.

Further, the apparatus disclosed in Patent Literature 1 (JP5-106127A) is for automatically mounting the cake. This literature merely discloses how to position the cake mount supporting the winded cake at the prescribed position of the corresponding twisting machine.

In view of the above issues of the related art, it is an object of the present invention to provide a transferring apparatus for a heavy object cassette as well as a transferring method for the heavy object cassette, which is mainly operable mechanically without using hydraulic pressure, by which it is easy to load the heavy object cassette and an operation speed is improved.

### Solution to Problem

To achieve the object of the present invention, the present invention provides a transferring apparatus for a heavy object cassette, which may include, but is not limited to:

a common plate member to which a plurality of support rods are attached on a support side of the support rods, the plurality of support rods being inserted in a plurality of holes formed in the heavy object cassette;

a play mechanism which allows adjustment of a relative position between the plurality of holes and the plurality of support rods by adjusting a position of the common plate member;

a lifting and lowering device which lifts and lowers the common plate member to which the support rods are attached and the play mechanism;

a base unit on which the lifting and lowering device is installed; and

a slide mechanism which supports the base unit movable forward and backward relative to a main body of the transferring apparatus.

According to the present invention, the position of the common plate member can be adjusted by the play mechanism, hence eliminating the need for fine-adjustment of the positions of the support rods and the holes. This makes it easy to insert the support rods in the holes.

More specifically, the support rods are attached to the common plate member on the support side of the support rods and the common plate member is supported by the play mechanism with entire motion freedom in the rotation direction and the up-down and left-right directions. Thus, the position relationship of the support rods is fixed to match the holes and the fine-adjustment between the support rods and the holes is performed by the play mechanism of the plate member. This makes it easy to insert the support rods in the holes. If the support rods are individually adjustable, it takes extra process for performing the fine-adjustment between the support rods and the holes, resulting in complicating the operation.

As described above, according to the present invention, inserting the support rods in the heavy object cassette is easier and the operation speed of the transferring apparatus for the heavy object cassette is improved, thereby improving the efficiency of the process.

Further, the lifting and lowering device is provided to lift and lower the common plate member to which the support rods are attached and the play mechanism, and the base unit is supported by the slide mechanism movable forward and backward relative to the main body of the transferring apparatus. Thus, it is possible to reduce the overall length and the size of the transferring apparatus for the heavy object cassette.

More specifically, the heavy object cassette is grabbed at an anterior end position of the main body of the transferring apparatus using the slide mechanism, the base unit is moved to the center part of the main body of the transferring apparatus via the slide mechanism to balance and then, the main body of the transferring apparatus is moved via the wheels with a steady balance. Therefore, the transferring apparatus can be moved in a steady and safe manner without increasing the overall length of the transferring apparatus. By this, it is also possible to reduce the size of the transferring apparatus as well as its overall lengths.

In the above transferring apparatus for the heavy object cassette,

at least one of the support rods may penetrate the common plate member and may be an eccentric support rod formed with a certain amount of eccentricity with respect to the common plate member, and

the transferring apparatus may further include:

a cassette immobilizing mechanism which immobilizes the heavy object cassette by rotating an eccentric part of the eccentric support rod to move the eccentric support rod in a radial direction and changing a relative position between the eccentric support rod and other support rods.

By providing the cassette immobilizing mechanism, the weight of the heavy object cassette can be supported by the rigid plate member by inserting the support rods in the holes formed horizontally in the heavy object cassette and the heavy object cassette can be picked and immobilized by the support rods so as to prevent the heavy object cassette from falling out of the support rods.

In this manner, the weight of the heavy object cassette is supported by the plurality of support rods fixed horizontally to the common plate member the weight of the heavy object cassette can be mechanically supported directly by the support rods so as to be movable in the horizontal direction without using the wire winch of the related art.

By this, the heavy object cassette which is substantially heavy can be supported easily and highly efficiently and without using the hydraulic pressure, there is no issue such as oil leaks.

Further, in the above transferring apparatus for the heavy object cassette, one support rod disposed in the lowest position among the support rods may penetrate the common plate member and may be an eccentric support rod formed with a certain amount of eccentricity with respect to the common plate member.

In this manner, the lowest support rod disposed in the lowest position among the support rods penetrates the common plate member and is the eccentric support rod formed with a certain amount of eccentricity with respect to the common plate member. Other support rods disposed above the eccentric support rod are used to lift the heavy object cassette and no support load is acting on the lowest support rod disposed in the lowest position and thus, the lowest support rod can be turned with small turning force compared to the other support rods disposed above the lowest support rod. Therefore, by simply turning the eccentric support rod which is the lowest support rod, the position of the eccentric support rod can be change in the radial direction. By this, a relative distance of the support rods changes relative to a relative distance of the holes formed in the heavy object cassette. Further, the heavy object cassette can be easily immobilized by grabbing the cassette by the support rods or holding the cassette firmly by the support rods in the case of expanding the relative distance of the support rods.

The support rods are, for instance, three support rods arranged circumferentially and one of the support rods is the eccentric support rod disposed at the lowest position among three support rods. In this manner, it is most practical to constitute the eccentric support rod of the support rod disposed at the lowest position among three support rods, as this requires fewer support rods and the cassette immobilizing mechanism is reliable and thus, this combination is most practical.

The above transferring apparatus for the heavy object cassette, may further include:

a locking mechanism which activates a brake on the main body of the transferring apparatus when a gate-type support is moved from a center part of the main body of the transferring apparatus by the slide mechanism.

In this manner, the main body of the transferring apparatus can be locked by the locking mechanism and thus, the insertion of the support rods in the holes of the heavy object cassette and also the lowering of the heavy object cassette from the placement table can be performed in a steady manner. By this, the above process can be performed positively and promptly.

Further, the locking mechanism may be activated when the lifting and lowering device lifts the gate-type support to a certain height or higher. By this, the main body of the transferring apparatus can be moved when the lifting and lowering device is at the central part of the main boy and at the certain height or lower. Thus, the main body of the transferring apparatus can be moved only in such a state that the balance is steady, thereby achieving the steady transferring while preventing it from falling.

The present invention also provides a method for transferring a heavy object cassette using a heavy-object-cassette transferring apparatus which transfers the heavy object cassette by rolling motion of a wheel while maintaining the heavy object cassette via a plurality of support rods inserted in a plurality of holes formed in the heavy object cassette, the method including, but not limited to, the steps of:

inserting the plurality of support rods fixed to a common plate member in the plurality of holes formed in the heavy object cassette;

in the inserting step, adjusting a relative position between the plurality of holes and the plurality of support rods by adjusting a position of the common plate member;

immobilizing the support rods having been inserted in the holes, with respect to the plurality of holes; and

after the immobilizing step, moving the heavy object cassette using a slide mechanism.

According to the present invention, the sequence of the inserting the support rods in the holes, adjusting the plate member in the inserting step, immobilizing the cassette after inserting and moving the heavy object cassette can be continuously performed by combining the following steps:

inserting the plurality of support rods in the plurality of holes formed in the heavy object cassette;
in the inserting step, adjusting the position of the support rods via the plate member;

immobilizing the support rods having been inserted in the holes, with respect to the plurality of holes; and

after the immobilizing step, moving the heavy object cassette using the slide mechanism, it is possible to achieve the effects listed below.

As a result, the heavy object cassette can be moved positively and efficiently.

Furthermore, in the above method for transferring the heavy object cassette,

in the immobilizing step, one of the support rods which penetrates the common plate member and which is an eccentric support rod formed with a certain amount of eccentricity, may be rotated so that the eccentric support rod is moved in a radial direction of the eccentric support rod to displace the relative position between the eccentric support rod and other support rods.

In this manner, by rotating the eccentric support rod, the eccentric support rod is moved in the radial direction of the eccentric support rod, thereby displacing the relative position between the eccentric support rod and other support rods. Therefore, the heavy object cassette can be picked up by the support rods and be easily immobilized.

In the above method for transferring the heavy object cassette,

a brake may be applied to a main body of the transferring apparatus when the support rods are inserted in the holes of the heavy object cassette using the slide mechanism or when the heavy object cassette is removed from a placement table for the heavy object cassette using the slide mechanism.

According to this method for transferring the heavy object cassette, the main body of the transferring apparatus can be locked by the locking mechanism and thus, the insertion of the support rods in the holes of the heavy object cassette and also the lowering of the heavy object cassette from the placement table can be performed in a steady manner. By this, the above process can be performed positively and promptly.

### Advantageous Effects of Invention

According to the present invention, the position relationship of the support rods fixed to the common plate member is matched in advance with the position relationship of the holes formed in the heavy object cassette, and by adjusting the position of the common plate in the rotation direction and the up-down and left-right directions by the play mechanism, an absolute position relationship between the support rods and the holes is fixed, while the fine adjustment between the support rods and the holes is performed by adjusting the position of the plate member. By this, the operation of inserting the support rods in the holes is easier and the support rods can be easily mounted in the heavy object cassette, hence improving the operation speed and the efficiency of the transferring apparatus for the heavy object cassette.

Further, the base unit having thereon the common plate member to which the support rods are fixed on the support side, the play mechanism for adjusting the position of the plate member, and the lifting and lowering device for lifting and lowering the plate member and the play mechanism, is supported by the slide mechanism so as to be movable frontward and rearward relative to the main body of the transferring apparatus. Thus, the heavy object cassette can be transferred in a steady manner without increasing the overall length of the transferring apparatus for the heavy object cassette and thus, it is possible to reduce the overall length and the size of the transferring apparatus.

Furthermore, the weight of the heavy object cassette can be mechanically supported directly by the support rods so as to be movable in the horizontal direction without using the wire winch of the related art. By this, the heavy object cassette which is substantially heavy can be supported easily and highly efficiently and without using the hydraulic pressure, there is no issue such as oil leaks.

### BRIEF DESCRIPTION OF DRAWINGS

FIG. 1 is a schematic side view of a transferring apparatus for a heavy object cassette in an embodiment of the present invention.

FIG. 2 is an oblique view of the embodiment taken from a direction of an arrow U of FIG. 1.

FIG. 3A shows a functional diagram of a play mechanism of FIG. 1.

FIG. 3B is an enlarged view of a section Z of FIG. 3A.

FIG. 4 is a view taken along a line A-A of FIG. 3A.

FIG. 5 shows a functional diagram of a locking mechanism of FIG. 1.

FIG. 6 is a schematic side view of a transferring apparatus for a heavy object cassette in relation to related art.

### DESCRIPTION OF EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present invention.

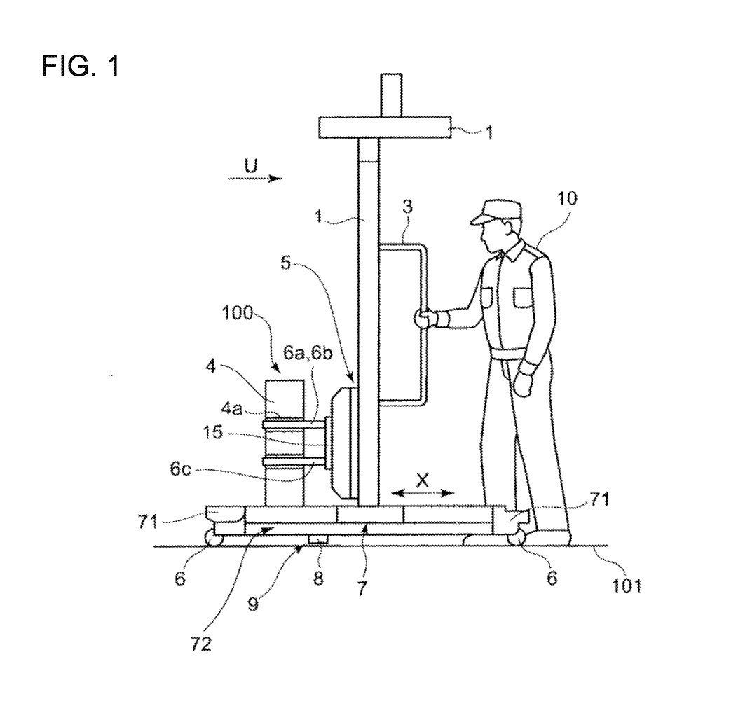

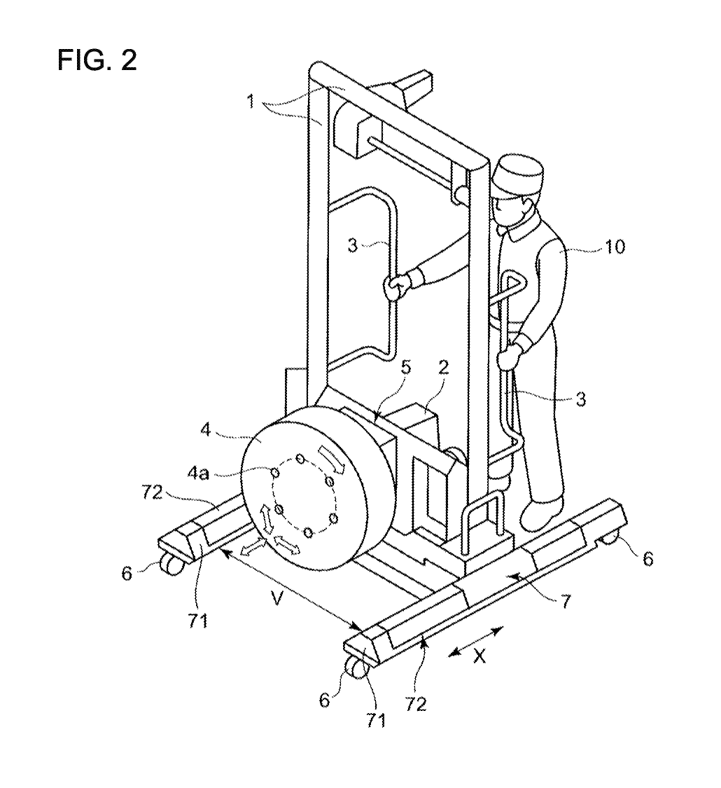

FIG. 1 is a schematic side view of a transferring apparatus for a heavy object cassette in an embodiment of the present invention. FIG. 2 is an oblique view of the embodiment taken from a direction of an arrow U of FIG. 1.

In FIG. 1 and FIG. 2, the transferring apparatus for the heavy object cassette 100 is configured as described below.

The heavy object cassette 4 is a cassette containing one heavy object therein. After completing a winding process of winding a belt-shaped material (not shown) around a drum-like member, the heavy object cassette 4 is placed on a placement table of a winding device. FIG. 1 shows the heavy object cassette 4 supported by the transferring apparatus 4 to remove the heavy object cassette 4 on the placement table from the placement table and then to place it on a transporting wagon.

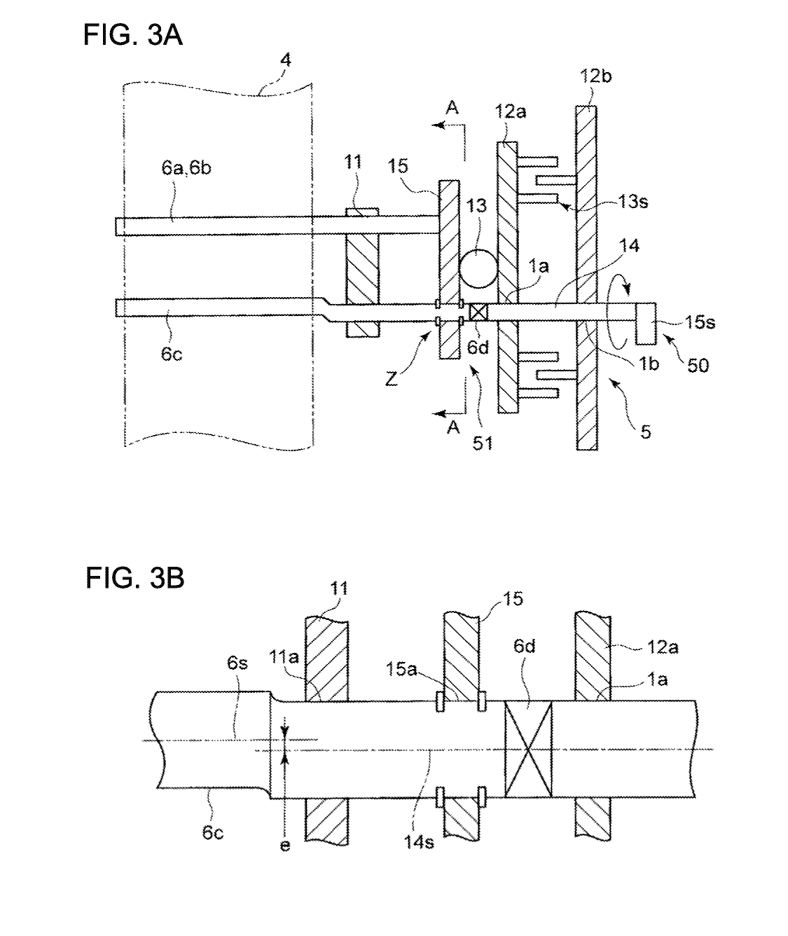

A base unit 7 is provided with a gate-type support (main body) 1 which is formed into a gate shape and is installed on the base unit 7. The gate-type support 1 is provided with handles 3 on both sides of the gate-type support 1 for an operator 10 to hold onto. On a front side of the gate-type support 1, a lifting and lowering device 5 equipped with a play mechanism 51 (see FIG. 3) is installed.

Further, the base unit 7 is configured manually movable with respect to a main body 71 of the transferring apparatus by the operator 10 in a direction of an arrow X via a sliding mechanism 72. Furthermore, the main body 71 of the transferring apparatus has two pairs of two wheels provided parallel to each other on left and right sides, the two pairs being arranged on front and rear sides of the main body 71. The slide mechanism 72 is provided with a stopper mechanism (not shown) for keeping the sliding mechanism 72 from sliding. By locking the slide mechanism 72 by means of the stopper mechanism, the transferring apparatus 100 for the heavy object cassette can be manually moved via the wheels 6 by the operator 10 pushing and pulling the transferring apparatus 100 by the handles 3.

The lifting and lowering device 5 is driven by an electric motor (not shown) and is movable up and down along a longitudinal part of the gate-type support 1.

The lifting and lowering device 5 is arranged on the front part of the gate-type support 1. The front part of the gate-type support 1 is formed with such a width that the heavy object cassette 4 is fitted within and with such a space V that a placement table cart for the heavy object cassette 4 can enter the space V as shown in FIG. 2.

The heavy object cassette 4 is a cassette containing one heavy object therein. For instance, the heavy object cassette 4 is formed by winding a thin belt-like plate around a round drum-like member and weighs approximately 100 kg or more and, as shown in FIG. 2, has six holes 6a horizontally formed through the drum-like member. The number of holes 4a is not limited as long as there are more holes 4a than support rods 6a, 6b, 6c.

FIG. 3A shows a functional diagram of a play mechanism of FIG. 1. FIG. 3B is an enlarged view of a section Z of FIG. 3A.

The lifting and lowering device 5 has a rear lateral part 12b which moves up and down along the gate-type support 1 and a front lateral part 12a which is arranged next to the rear lateral part 12b via a joint 13s.

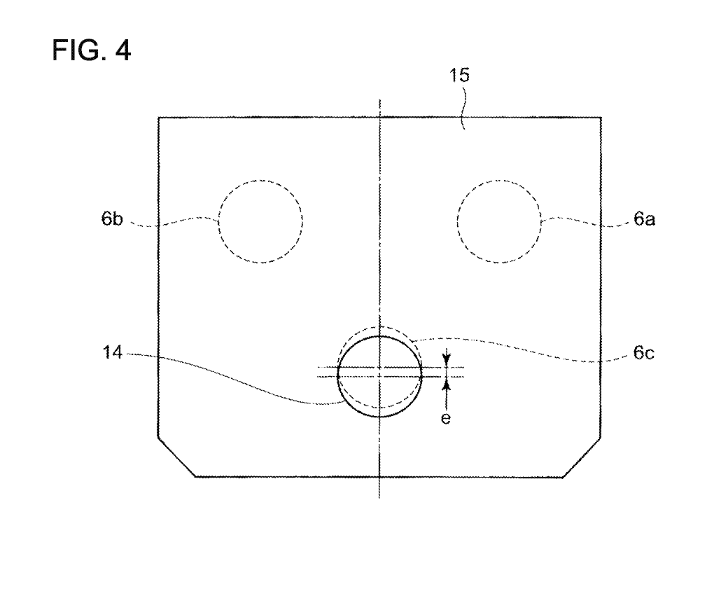

On the front part of the lifting and lowering device 5, two support rods 6a, 6b and one eccentric support rod 6c are attached to a common steel plate (a plate member) 15 at equal intervals in a circumferential direction as shown in FIG. 4. The support rods 6a, 6b, 6c are insertable in six holes 4a formed in the heavy object cassette 4.

Those two support rods 6a, 6b are fixed to a front part of the steel plate 15, i.e. a support side. The eccentric support rod 6c penetrates the steel plate 15 and extends rearward as shown in FIG. 3A and FIG. 3B. Those three support rods 6a, 6b, 6c penetrate a securing plate 11 arranged on a front side of the steel plate 15 so as to improve support stiffness.

As shown in FIG. 3B, the eccentric support rod 6c is supported rotatably by the steel plate 15 and the securing plate 11 at a front end part (support points 15a, 11a) and at a rear end part, penetrates the front lateral part 12a and the rear lateral part 12b (support points 1a, 1b) and extends rearward.

On a front side of the securing plate 11, a center 6s of the eccentric support rod 6c is eccentrically displaced with a certain amount of eccentricity “e” from a center 14s. At an end of the eccentric support rod 6c, a handle 15s is provided to rotate the eccentric support rod 6c. The eccentric support rod 6c is inserted through and supported rotatably by the steel plate 15 and also secured by a bush to prevent the eccentric support rod 6c from moving in an axial direction. In this manner, the cassette immobilizing mechanism 50 is formed by the eccentric support rod 6c and the handle 15s for rotating the eccentric support rod 6c.

The steel plate 15 is supported rotatably and swingably via a ball join 13 arranged rollable between the steel plate 15 and the front lateral part 12a. The range of rotation and swing is restricted by the steel plate 15 contacting another member. Further, to allow the eccentric support rod 6c to accommodate rotating and swinging motion of the steel plate 15, an universal joint mechanism 6d is installed between the steel plate 15 and the front lateral part 12a. In this manner, the play mechanism 51 is configured such that the steel plate 15 is supported movable in the rotation direction and the up-down and left-right directions with respect to the front lateral part 12a.

Therefore, in response to the movement of the steel plate 15 such as rotating and swinging thereof, a direction and a position of the support rods 6a, 6b fixed to the steel plate 15 and the eccentric support rod 6c penetrating the steel plate 15 as a whole can be freely adjusted without changing a position relationship between the support rods 6a, 6b and the eccentric support rod 6c.

Alternatively, instead of the universal joint mechanism 6d, holes in the steel plate 15 may be formed slightly bigger than the diameter of the eccentric support rod 6c so as to accommodate the swinging motion of steel plate 15.

Further, between the front lateral part 12a and the rear lateral part 12b, a joint 13s may be provided slidably in a front-back direction to absorb a displacement between the gate-type support 1 and the lifting and lowering device 5 in the front-back direction.

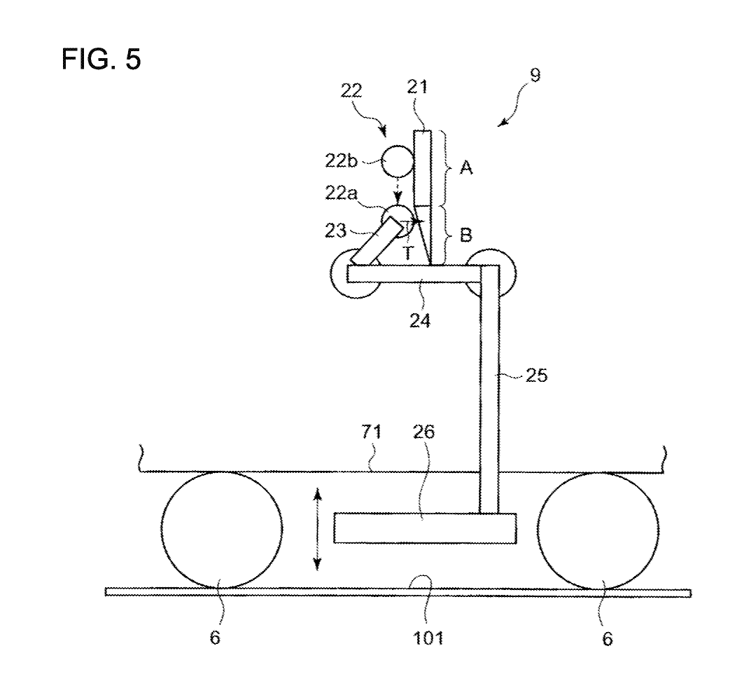

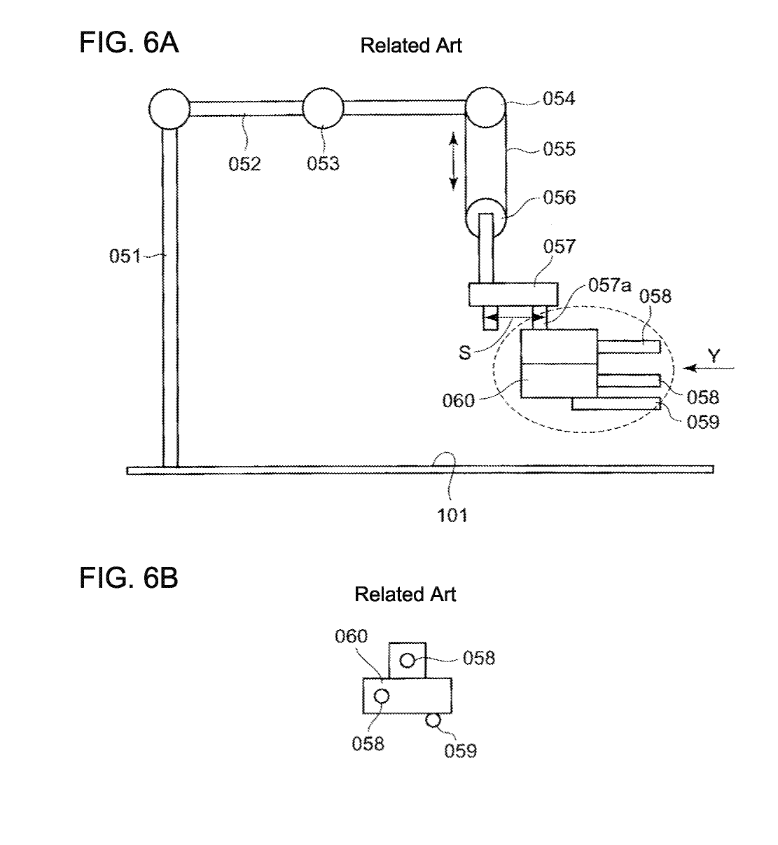

FIG. 5 shows a functional diagram of the locking mechanism 9 of FIG. 1. A rail 21 is arranged movable up and down in conjunction with the lifting and lowering device 5 moving up and down along the gate-type support 1. The rail 21 includes a parallel part A and an oblique part B. A roller 22 is supported by the main body 71 of the transferring apparatus via a link mechanism and moves up and down along the rail 21.

When the roller 22 is at a point 22a of the rail 21, the roller 22 moves in a direction of an arrow T at the oblique part B, thereby causing a connecting link 23, 24, 25 to move downward. This causes the brake 26 to contact the ground 101, thereby braking the main body 71 of the transferring apparatus.

When the roller 22 is at a point 22b, the roller 22 is along the parallel part A, thereby causing the connecting link 23, 24, 25 to move upward. This causes the brake 26 to be lifted from the ground 101, thereby releasing the brake.

The connecting link 23, 24, 25 is supported on the main body side 71 and the roller 22 is arranged approximately in the center of the main body 71 of the transferring apparatus in the longitudinal direction. When the lifting and lowering device 5 provided with the rail 21 is approximately in the center of the main body 71 of the transferring apparatus and is at a prescribed height or lower, the roller 22 is at the parallel part A, thereby causing the connection link 23, 24, 25 to move upward, and releasing the brake 26. This causes the main body 71 of the transferring apparatus movable using the wheels 6.

Further, when the lifting and lowering device 5 is not in the central position or when the lifting and lowering device 5 is at the prescribed height or higher, the roller 22 is at the oblique part B or is not engaged with the rail 21. This causes the brake 26 to come down and to contact the ground 101, thereby applying the brake. As a result, the main body 71 of the transferring apparatus is locked.

More specifically, in the process of inserting the support rods 6a, 6c in the holes 4a of the heavy object cassette 4 or in the process of removing the heavy object cassette 4 from the placement table, the brake is applied to the main body 71 of the transferring apparatus. Thus, the process of inserting the support rods 6a, 6c in the holes 4a of the heavy object cassette 4 as well as the process of removing the heavy object cassette 4 from the placement table can be performed in a steady manner, positively and fast.

The advantages and effects of the embodiment are now described.

To fit the space V at the front part of the gate-type support 1 in a position of the placement cart for the heavy object cassette 4, the main body 71 of the transferring apparatus is moved via the wheels 6. Once arriving at a position to transfer the heavy object cassette 4, the base unit 7 is manually moved by the operator 10 frontward in FIG. 1 via the slide mechanism 72 and the lifting and lowering device 5 is set at an appropriate position above using the electric motor. In this process, the brake is applied to the main body 71 of the transferring apparatus using the locking mechanism 9.

By advancing the lifting and lowering device 5 frontward via the base unit 7, the support rods 6a and 6b and the eccentric support rod 6c can be inserted in the corresponding three holes 4a among the six holes 4a formed horizontally in the heavy object cassette 4.

In the insertion process, the position relationship of the support rods 6a, 6b, 6c fixed to the steel plate 15 is matched in advance with the position relationship of the holes 4a formed in the heavy object cassette 4, and by adjusting the position of the steel plate 15 in the rotation direction and the up-down and left-right directions by the play mechanism 51, and further by moving the base unit 7 freely frontward and rearward via the slide mechanism 72, the direction and the position of the support rod 6a, 6b and the eccentric support rod 6c as a whole can be freely adjusted and thus, it is possible to finely adjust a space between the holes and the support rods and also to easily insert the support rods 6a, 6b, 6c in the holes 4a.

The eccentric support rod 6c is supported rotatably by the rigid steel plate 15 at the support point 15a and the rear end part is supported rotatably by the lateral parts 12a, 12b at the support points la, lb. In the front end portion of the eccentric support rod 6c, the center 6s of the eccentric support rod 6c is eccentric with respect to the center 14s of the support point with a certain amount of eccentricity “e” and thus, by turning the handle 15s provided at the end of the eccentric support rod 6c to change the direction of the eccentricity “e” as shown in FIG. 4, i.e. by changing the position of the eccentric support rod 6c in the radial direction, the relative position of the support rods changes relative to the relative position of the holes formed in the heavy object cassette 4. By this, the heavy object cassette 4 is grabbed by the support rods or held firmly by the support rods 6a, 6c in the case of expanding the relative position among the support rods.

The one support rod disposed in the lowest position among the three support rods disposed circumferentially, is the eccentric support rod 6c. Thus, the two support rods 6a, 6b disposed above the eccentric support rod 6c are used to lift the heavy object cassette 4 and no support load is acting on the lowest support rod disposed in the lowest position and thus, the lowest support rod can be turned with small turning force compared to the other support rods disposed above the lowest support rod. Therefore, by forming the eccentric support rod 6c by the lowest support rod, the heavy object cassette can be immobilized by an easy operation.

According to the embodiment, the lifting and lowering device 5 including the play mechanism 51 and the base unit 7 having the gate-type support 1 installed thereon for supporting the lifting and lowering device 5 are manually movable by the operator 10 in the X direction of FIG. 1 with respect to the main body 71 of the transferring apparatus. By this, the overall length of the transferring apparatus for the heavy object cassette can be shorter, thereby reducing the transferring apparatus in size.

More specifically, the gate-type support 1 is moved to an anterior end position via the slide mechanism 72 to grab and hold the heavy object cassette 4 and then, the base unit 7 is moved to the center part of the main body 71 of the transferring apparatus via the slide mechanism 72 to balance and thus, the main body 71 of the transferring apparatus can be moved via the wheels 6 with a steady balance. Therefore, the transferring apparatus can be moved in a steady and safe manner and the heavy object cassette 4 can be transferred in a steady manner with balance without increasing the overall length of the transferring apparatus 100. By this, it is also possible to reduce the size of the transferring apparatus as well as its overall lengths.

The weight of the heavy object cassette 4 is supported by the three support rods 6a, 6b, 6c fixed horizontally to the rigid steel plate 15 and, by moving the common steel plate 15 in the rotation direction and the up-down and left-right directions using the play mechanism 51 and the slide mechanism 72, the gap between the three support rods 6a, 6b, 6c and the horizontal holes 4a respectively is adjusted. Therefore, without using a conventional wire winch, the heavy object cassette 4 can be mechanically supported directly and transferred horizontally and thus, the transferring speed and the efficiency are improved. Further, the transferring apparatus is of a mechanical type and thus, there is no issue such as oil leaks.

Further, according to the embodiment, the lifting and lowering device 5 supported by the gate-type support 1 is off the central position of the main body 71 of the transferring apparatus, or when the lifting and lowering device 5 is at a prescribed height or higher, the brake 26 lowers and is pressed against the ground 101 to apply the brake, thereby locking the main body 71 of the transferring apparatus so as not to be able to move. Thus, in the process of inserting the support rods 6a, 6b, 6c in the holes 4a of the heavy object cassette 4, the heavy object cassette can be removed from the placement table in a steady manner and the operation can be performed firmly and promptly.

In the above structure, it is most practical to fix three support rods 6a, 6b, 6c to the common rigid steel plate 15, one of which is the eccentric support rod 6c which penetrates the steel plate 15 and is formed with the eccentricity “e”. However, this is not limitative and three or more support rods may be provided while one eccentric support rod is provided.

In the above embodiment, by performing the following steps in the order:

inserting the plurality of support rods fixed to the common plate member in the plurality of holes formed in the heavy object cassette;

in the inserting step, adjusting the gap between the holes and the support rods by adjusting the position of the plate member;

immobilizing the support rods having been inserted in the holes, with respect to the plurality of holes; and

after the immobilizing step, moving the heavy object cassette using the slide mechanism, it is possible to achieve the effects listed below.

Specifically, by performing the inserting step, the adjusting step, the immobilizing step and the moving step continuously, it is possible to transfer the heavy object cassettes 4 effectively.

Further, in the immobilizing step, one support rod 6c connected to the steel plate 15 is an eccentric support rod and, the eccentric support rod 6c is moved in the radial direction thereof by turning the eccentric support rod 6c so as to displace the relative position between the eccentric support rod 6c and other support rods 6a. Thus, the heavy object cassette 4 is firmly and easily immobilized with respect to the support rods 6a, 6c and the subsequent step of transferring the heavy object cassette 4 can be performed easily.

When the heavy object cassette 4 is removed from the placement table for the heavy object cassette using the slide mechanism 72, the brake is applied to the main body 71 of the transferring apparatus using the locking mechanism 9. Thus, the step of inserting the support rods in the holes of the heavy object cassette can be performed positively and promptly.

### INDUSTRIAL APPLICABILITY

According to the present invention, it is possible to provide the transferring apparatus for the heavy object cassette as well as the transferring method for the heavy object cassette, which is entirely mechanically operable without using hydraulic pressure, by which it is easy to load and unload the heavy object cassette, and which operates at high speed.

1. A transferring apparatus for a heavy object cassette, comprising:
a common plate member to which a plurality of support rods are attached on a support side of the support rods, the plurality of support rods being inserted in a plurality of holes formed in the heavy object cassette;
a play mechanism which allows adjustment of a relative position between the plurality of holes and the plurality of support rods by adjusting a position of the common plate member;
a lifting and lowering device which lifts and lowers the common plate member to which the support rods are attached and the play mechanism;
a base unit on which the lifting and lowering device is installed; and
a slide mechanism which supports the base unit movable forward and backward relative to a main body of the transferring apparatus.

2. The transferring apparatus for the heavy object cassette according to claim 1,
wherein at least one of the support rods penetrates the common plate member and is an eccentric support rod formed with a certain amount of eccentricity with respect to the common plate member, and
wherein the apparatus further comprises:
a cassette immobilizing mechanism which immobilizes the heavy object cassette by rotating an eccentric part of the eccentric support rod to move the eccentric support rod in a radial direction and changing a relative position between the eccentric support rod and other support rods.

3. The transferring apparatus for the heavy object cassette according to claim 2,
wherein, in the cassette immobilizing mechanism, one of the support rods disposed in a lowest position among the plurality of support rods is the eccentric support rod.

4. The transferring apparatus for the heavy object cassette according to claim 1, further comprising:
a locking mechanism which activates a brake on the main body of the transferring apparatus when a gate-type support is moved from a center part of the main body of the transferring apparatus by the slide mechanism.

5. The transferring apparatus for the heavy object cassette according to claim 4,
wherein the locking mechanism is activated when the lifting and lowering device lifts the gate-type support by a certain amount or greater.

6. A method for transferring a heavy object cassette using a heavy-object-cassette transferring apparatus which transfers the heavy object cassette by rolling motion of a wheel while maintaining the heavy object cassette via a plurality of support rods inserted in a plurality of holes formed in the heavy object cassette, the method comprising the steps of:
inserting the plurality of support rods fixed to a common plate member in the plurality of holes formed in the heavy object cassette;
in the inserting step, adjusting a relative position between the plurality of holes and the plurality of support rods by adjusting a position of the common plate member;
immobilizing the support rods having been inserted in the holes, with respect to the plurality of holes; and
after the immobilizing step, moving the heavy object cassette using a slide mechanism.

7. The method for transferring the heavy object cassette according to claim 6,
wherein, in the immobilizing step, one of the support rods which penetrates the common plate member and which is an eccentric support rod formed with a certain amount of eccentricity, is rotated so that the eccentric support rod is moved in a radial direction of the eccentric support rod to displace the relative position between the eccentric support rod and other support rods.

8. The method for transferring the heavy object cassette according to claim 6,
wherein a brake is applied to a main body of the transferring apparatus when the support rods are inserted in the holes of the heavy object cassette using the slide mechanism or when the heavy object cassette is removed from a placement table for the heavy object cassette using the slide mechanism.
